(19) United States
(12) Patent Application Publication
(10) Pub. No.: US 2023/0158595 A1
(43) Pub. Date: May 25, 2023

(54) PREDICTION AND CONTROL OF PRODUCT SHAPE QUALITY IN WIRE AND ARC ADDITIVE MANUFACTURING THROUGH MACHINE LEARNING

(71) Applicant: University of Southern California, Los Angeles, CA (US)

(72) Inventors: Qiang Sean HUANG, Rancho Palos Verdes, CA (US); Cesar Alexander RUIZ TORRES, Norman, OK (US)

(21) Appl. No.: 17/992,258

(22) Filed: Nov. 22, 2022

Related U.S. Application Data
(60) Provisional application No. 63/281,949, filed on Nov. 22, 2021.

(51) Int. Cl. B23K 9/04; B23K 9/12

(52) U.S. Cl. CPC B23K 9/042; B23K 9/124; B33Y 10/00

(57) ABSTRACT

A generalized additive modeling approach to separate global geometric shape deformation from surface roughness is provided. Under this statistical framework, tensor product basis expansion is adopted to learn both the low-order shape deformation and high-order roughness patterns. The established predictive model enables the optimal geometric compensation for product redesign to reduce shape deformation from the target geometry without altering process parameters. Experimental validation on WAAM manufactured cylindrical walls of various radi shows the effectiveness of the proposed framework.

### CROSS-REFERENCE TO RELATED APPLICATIONS

This application claims the benefit of U.S. provisional application Ser. No. 63/281,949 filed Nov. 22, 2021, the disclosure of which is hereby incorporated in its entirety by reference herein.

### TECHNICAL FIELD

In at least one aspect, the present invention relates to systems and methods for reducing deformation in part fabricated by wire and arc additive manufacturing.

### BACKGROUND

In recent years, metal additive manufacturing (AM) technologies have attracted significant interest to meet the growing demand for rapid product design and development and for building geometrically complex parts. Metal AM technologies can be classified into powder feeding systems, wire feeding systems, and powder bed systems [1]. Compared to powder-based processes, wire-feed AM typically has a larger built area and higher deposition rate but lower geometric precision [2]. The wire and arc additive manufacturing (WAAM) technique makes use of traditional arc welding technology to deposit material layer by layer. Plasma arc welding (PAW), gas metal arc welding (GMAW) and gas tungsten arc welding (GTAW) have been applied to create weld pools and melt the wire feedstock [3]. The feedstock materials include carbon steel, aluminum alloy, nickel alloy, and titanium alloy [4]. Thanks to GMAW's high energy input, high deposition rate, and low-cost equipment [5], metal AM based on GMAW offers substantial benefits over powder bed and powder feed systems for near-net shape production of large-size parts used in the aerospace and oil industries [6]. However, WAAM technologies suffer from large shape deviations and high surface roughness. In GMAW, for example, the filler material is melted with an electrical arc between the wire electrode and the top layer surface. During fabrication, layers are repeatedly subjected to re-heating and cooling processes, and the generated heat stresses due to the multiple fusion, solidification and phase change cycles are extremely nonlinear and transient. This results in significant residual stresses as well as shape deviation, which are some of the primary deterrents for the widespread adoption of WAAM technologies [7, 8].

To achieve the desired final part geometry and metallurgical properties [7], process characterization of new materials and new geometrical features are regularly carried out to optimize deposition pattern, heat input, and deposition speed, among other variables. It involves experimentation of depositing a single-track, single-layer, multilayer, and certain geometrical features such as crossing, cylinder geometry, or bulk material to identify a desirable deposition process window. However, root causes of part shape deviations can come from multiple sources [9], such as (1) geometric approximation error introduced by the conversion from CAD model to the desired input file for printing, (2) material-related distortion and shrinkage caused by the repeated heating and cooling process, and (3) process-induced error caused by machine errors such as machine axis misalignment. Comprehensive process characterization is cost-prohibitive and time-consuming for large WAAM fabricated parts, particularly when part design changes frequently.

To reduce the number of physical experiments used for process characterization, numerical studies have been devoted to physics-based pattern generation [10], thermal and stress distribution modeling [11,12], and microstructure and mechanical property evaluation of WAAM produced parts [3, 13, 14, 15, 16, 17]. Among others, Mughal et al. [5] examined residual stress deformation of GMAW using finite element modeling and concluded that thermal cycling was the principal source of deformation. Zhao et al. developed a thermal model and demonstrated that the deposition orientation could affect the heat diffusion and the distribution of residual stresses. In situ process monitoring has also been developed to control the width and height of each layer during the WAAM fabrication process [19, 20, 21, 22, 23]. However, physics-based simulation and prediction of WAAM part deformation involve not only a large number of process variables (e.g., energy input, temperature regime, and material properties, etc.), but also the non-smooth surfaces between overlapping bead layers [7], complicated layer interactions, and high residual stresses. Therefore, the simulation of large-size parts is computationally prohibitive. The deposited multilayer geometries are often inconsistent with the design even when the theoretical relationship between printed layer geometry and process parameters is well understood for simple and small geometries [24].

Accordingly, there is a need for methods and systems for reducing deformation is parts fabricated by wire and arc additive manufacturing.

### SUMMARY

In at least one aspect, a method for forming a target object by wire and arc additive manufacturing is provided. The method includes steps of receiving, by a computing device, an initial three dimensional model of the target object to be fabricated by wire and arc additive manufacturing and applying a compensation plan to the initial three-dimensional model to form a modified three-dimensional model to compensate for deformation during fabrication of the target object. The compensation plan is determined by the computing device with a computer implement method that includes steps of converting point-cloud to functional data for each training object in a set of training objects; calculating total shape deviations for each training object; constructing an engineering-informed tensor-product basis representation of the deformation and roughness patterns for each training object; learning deformation and roughness patterns that constitute total shape deviations from the set of training objects; and creating an optimal compensation plan from the predicted deformation patterns to be applied to the target object that minimizes shape deformation. The target object is formed by wire and arc additive manufacturing with the modified three-dimensional model.

In another aspect, a method for determining a compensation plan to be applied to an initial three-dimensional model to form a modified three-dimensional model to compensate for deformation during the fabrication of a target object The method includes steps of converting point-cloud to functional data for each training object in a set of training objects; calculate shaping deviations for each training object; applying an engineering-informed tensor-product basis representation of deformation and roughness for each training object; learning deformation and roughness patterns that constitute shape deviations from the set of training objects; and creating an optimal compensation plan from the deformation and roughness patterns to be applied to the target object that minimizes deviations for a predicted deformation.

In another aspect, a non-transitory storage medium encodes instructions to execute the method for determining a compensation plan to be applied to an initial three-dimensional model to form a modified three-dimensional model to compensate for deformation during the fabrication of a target object.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a further understanding of the nature, objects, and advantages of the present disclosure, reference should be made to the following detailed description, read in conjunction with the following drawings, wherein like reference numerals denote like elements and wherein:

FIG. 1. Shape deviation (mm) surface of a 60 mm radius stainless-steel 316L cylindrical wall manufactured using the GMAW process.

FIG. 2. Shape deviation for 2D cylinders printed using an SLA machine before (SLA A) [26] and after repair (SLA B) [34], and the center of layers 3, 7, and 11 of the 40 and 60 mm radius cylindrical walls (WAAM).

FIG. 3A. Schematic flowchart illustrating a method for forming a target object by wire and arc additive manufacturing are schematically illustrated.

FIG. 3B. Schematic illustration of system for forming a target object by wire and arc additive manufacturing are schematically illustrated.

FIG. 3C. Schematic of a computing device used in the method and system of FIGS. 1A and 1B.

FIG. 4. GMAW cell used for printing the samples.

FIG. 5. CAD models (left) and manufactured samples (right) used in this study.

FIG. 6. Summary of the proposed GAM framework for shape deviation modeling and compensation in WAAM.

FIG. 7. Surface deviation of the 6 mm thick cylindrical walls.

FIG. 8. Illustration of the CCS.

FIG. 9. Low order univariate basis expansions used in this study.

FIG. 10. Basis functions values at r0=35 mm of a tensor product basis with 5 cyclic cubic basis for θ, 3 TPRS for z, and 3 TPRS for r0. Top: fixed θ=π, bottom: fixed z=20.

FIG. 11. Reparameterized low order tensor-product basis for different r0.

FIG. 12. Predicted shape deviation of 3 layers in all cylindrical walls in the training data set.

FIG. 13. Predicted shape deformation for three layers of the r₀=25 mm cylinder.

FIG. 14. Predicted deformation (green line), shape deviation (blue dots) and predicted shape deviation after compensation (orange dots) at the center of layers 3, 9, and 18 for the 40 mm cylinder under the SR model.

FIG. 15. Predicted shape deformation and compensation plan for the r₀=50 mm cylindrical wall.

FIG. 16. Layer-wise compensation plan for the 50 mm cylindrical wall under the SR model.

FIG. 17. Shape deviation profiles of uncompensated and compensated 50 mm cylindrical walls.

FIG. 18. Shape deviation and smoothed shape deformation (using 5 cyclic cubic basis) at the center of layers 3, 9, and 18 for uncompensated and compensated parts.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of excludes any element, step, or ingredient not specified in the claim. When this phrase appears in a clause of the body of a claim, rather than immediately following the preamble, it limits only the element set forth in that clause; other elements are not excluded from the claim as a whole.

The phrase” consisting essentially of limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

With respect to electrical devices, the term “connected to” means that the electrical components referred to as connected to are in electrical communication. In a refinement, “connected to” means that the electrical components referred to as connected to are directly wired to each other. In another refinement, “connected to” means that the electrical components communicate wirelessly or by a combination of wired and wirelessly connected components. In another refinement, “connected to” means that one or more additional electrical components are interposed between the electrical components referred to as connected to with an electrical signal from an originating component being processed (e.g., filtered, amplified, modulated, rectified, attenuated, summed, subtracted, etc.) before being received to the component connected thereto.

The term “electrical communication” means that an electrical signal is either directly or indirectly sent from an originating electronic device to a receiving electrical device. Indirect electrical communication can involve the processing of the electrical signal, including but not limited to, filtering of the signal, amplification of the signal, the rectification of the signal, modulation of the signal, attenuation of the signal, adding of the signal with another signal, subtracting the signal from another signal, subtracting another signal from the signal, and the like. Electrical communication can be accomplished with wired components, wirelessly connected components, or a combination thereof.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

The term “electrical signal” refers to the electrical output from an electronic device or the electrical input to an electronic device. The electrical signal is characterized by voltage and/or current. The electrical signal can be stationary with respect to time (e.g., a DC signal) or it can vary with respect to time.

It should be appreciated that in any figures for electronic devices, a series of electronic components connected by lines (e.g., wires) indicates that such electronic components are in electrical communication with each other. Moreover, when lines directed connect one electronic component to another, these electronic components can be connected to each other as defined above.

Embodiments, variations, and refinements of the neural networks and the operations described in this specification can be implemented in digital electronic circuitry, or in computer software, firmware, or hardware, including the structures disclosed in this specification and their structural equivalents, or in combinations of one or more of them.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

When a computing device is described as performing an action or method step, it is understood that the computing device is operable to perform the action or method step typically by executing one or more lines of source code. The actions or method steps can be encoded onto non-transitory memory (e.g., hard drives, optical drives, flash drives, and the like).

The term “computing device” generally refers to any device that can perform at least one function, including communicating with another computing device. In a refinement, a computing device includes a central processing unit that can execute program steps and memory for storing data and a program code. Computing devices can be laptop computers, desktop computers, servers, smart devices such as cell phones and tablets, and the like.

The term “neural network” refers to a machine learning model that can be trained with training input to approximate unknown functions. In a refinement, neural networks include a model of interconnected digital neurons that communicate and learn to approximate complex functions and generate outputs based on a plurality of inputs provided to the model.

The term “multimodal learning” refers to learning using data from different domains or modalities.

The term “point cloud data” refers to a set of data points that represent a 3D shape or object in space. Typically, each point position in the point clound has an associated set of Cartesian coordinates (x, y, z). Point cloud data can be generated by 3D scanners.

Throughout this application, where publications are referenced, the disclosures of these publications in their entireties are hereby incorporated by reference into this application to more fully describe the state of the art to which this invention pertains.

Abbreviations:

“GAM” means generalized additive models.

“GMAW” means gas metal arc welding.

“WAAM” means wire and arc additive manufacturing.

In at least one aspect, a learning approach is developed to predict the shape deviation of as-printed WAAM parts. From the prediction model, an optimal design compensation plan is derived to modify the CAD design to obtain the desired geometry upon manufacturing. This strategy is based on the prescriptive modeling approach and effect equivalence principle that has been established for other AM processes [25, 26, 27, 28, 29, 30, 31, 32]. It starts with extracting the geometric deviation patterns from point-cloud data through fabrication-aware machine learning and then minimizing shape deviations through the optimal compensation algorithms [26, 33].

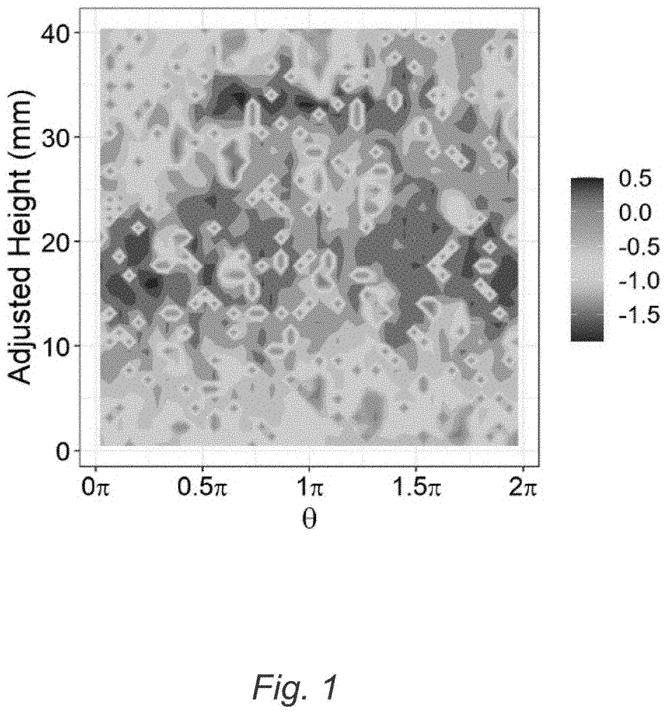

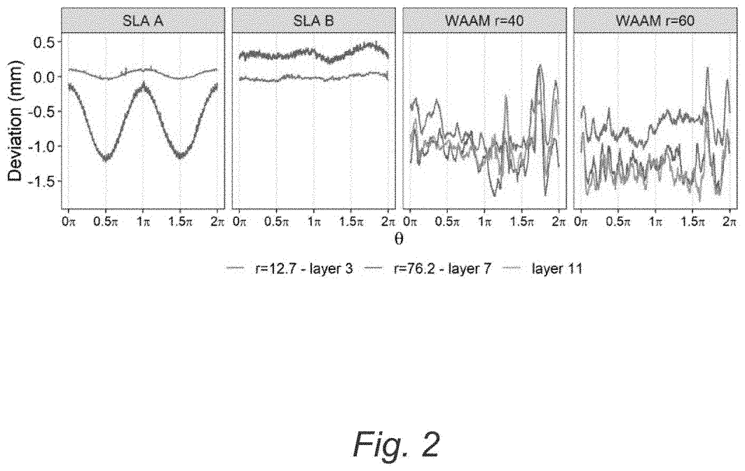

However, directly implementing this strategy to WAAM processes faces a unique challenge, that is, parts having large shape deformation and high surface roughness at the same time. As an example, FIG. 1 illustrates the shape deviation profile of a WAAM built cylindrical wall. The deviation patterns on the flattened outer wall are highly volatile. As a comparison, shape deviation in a Stereolithography (SLA) process and WAAM is illustrated in FIG. 2. Clearly, the total shape deviation of the SLA printed parts is dominated by uneven material shrinkage with much smaller surface roughness [26]. In contrast, the WAAM manufactured part exhibits changing deviation patterns with large surface roughness varying at different spatial locations such as near 1.75π where arc ignition occurs. Accurate separation of local surface roughness from global shape deformation is, therefore, nontrivial. This has been demonstrated in a study of laser powder bed fusion (LPBF) processes where part size is significantly smaller [29].

Information extraction from 2D high-dimensional data sets with significant noise is a common problem in many applications such as medical imaging [35] and structural health monitoring [36]. Popular approaches for identifying relevant patterns include robust principal component analysis [37], wavelet decomposition [36], additive tensor decomposition [38], smooth-sparse decomposition [39], among others [40]. These methods require the data to be sampled on a regular grid and decompose the data into smooth and sparse components. Although they can handle missing entries, geometric accuracy data is obtained as point-clouds sampled at random locations, and it contains global and local smooth patterns. For such data sets, Kriging methods and generalized additive models (GAMs) [41] offer more flexible alternatives, with the later being more computationally efficient for large data sets.

To reduce part deformation (not surface roughness), embodiments of the invention model part shape deviation using a GAM. These models use penalty terms to control the smoothness of each function which allows for main trends that are much less smooth than local patterns [42]. We mathematically decompose shape deviation into the main shape deformation trend and surface roughness as a function of the local geometrical features in the cylindrical coordinate system. Each term is modeled using tensor-product basis functions with a univariate basis informed by knowledge of the physical characteristics of WAAM built parts. Then, we use the predicted in-plane deformation pattern to introduce layer-wise optimal geometric compensation in the CAD design of new parts.

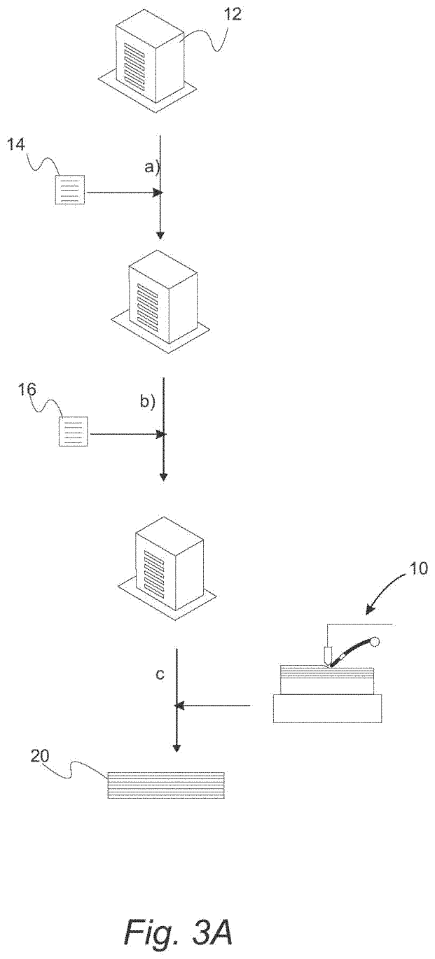

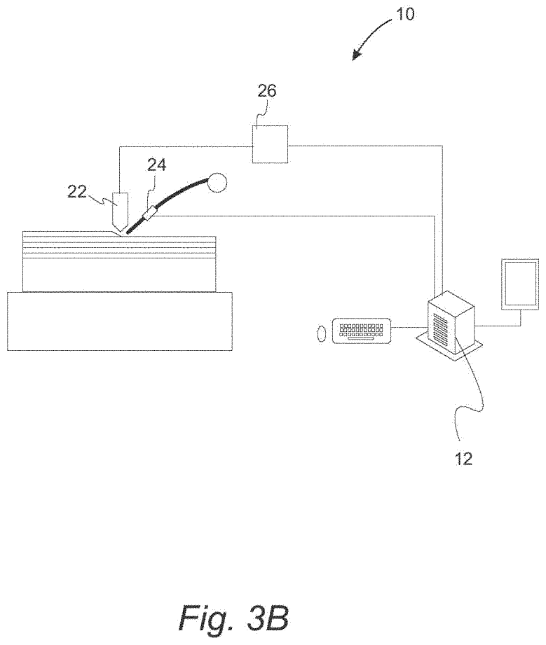

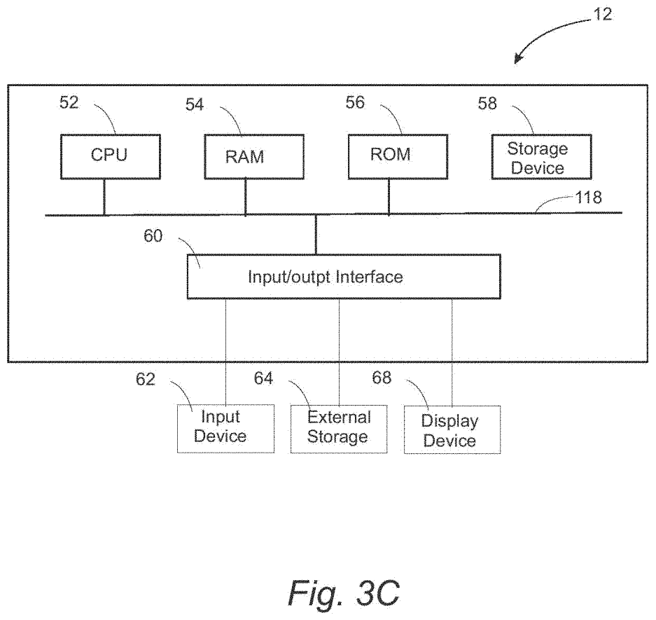

With reference to FIGS. 3A and 3B, a method and system for forming a target object by wire and arc additive manufacturing are schematically illustrated. In general, a target object is formed by wire and arc additive manufacturing machine 10. In step a), computing device 12 receives an initial three-dimensional model 14 of the target object to be fabricated by wire and arc additive manufacturing. In step b), a compensation plan 16 is applied by computing device 12 is applied to the initial three-dimensional model to form a modified three-dimensional model to compensate for deformation during the fabrication of the target object. Characteristically, the compensation plan is determined by the computing device with a computer implement method comprising steps of:
1) converting point-cloud to functional data for each training object in a set of training objects;
2) calculate shaping deviations for each training object;
3) applying an engineering-informed tensor-product basis representation of deformation and roughness for each training object;
4) learning deformation and roughness patterns that constitute shape deviations from the set of training objects; and
5) creating an optimal compensation plan from deformation and roughness patterns to be applied to the target object that minimizes deviations for a predicted deformation. In this context, an optimal compensation plan is a revised design (e.g., CAD design) that reduces deviations, and in particular, deformations to a sufficient extent that the object is acceptable for its intended use. In a refinement, the optimal compensation plan can be the output of a trained machine learning algorithm for an object to be fabricated. In step c), target object 20 is formed by wire and arc additive manufacturing using machine 10 with the modified three-dimensional model. The methods disclosed herein can be used to fabricate complicated shapes such target objects having a net shape.

As depicted in FIG. 3B, wire and arc additive manufacturing using machine 10 includes a torch 22, wire-feed system 24, and power supply/control electronics 26. The arch torch and wire feed being in electrical communication with the computing device and receiving instructions therefrom for forming the target object. In particular, wire and arc additive manufacturing using machine 10 is operated in accordance to a CAD design that incorporated therein the optimal compensation plan.

Advantageously, the optimal compensation plan minimizes the absolute volume deviations. In one variation, the optimal compensation plan minimizes area deviations. In a refinement, the optimal compensation plan minimizes total absolute area deviation. In another refinement, the optimal compensation plan minimizes deviations for predicted deformation by calculating an amount of compensation that is equivalent to an area deviation.

In a refinement as set forth below, the target object can have a circular cross-section (e.g., a cylinder). In such an example, the shape deviations are given by:

$${y}_{k} ( 𝓏 , θ , {r}_{0} ) = {\sum }_{i = 1}^{{κ}_{1}} {Ψ}_{i} ( θ , 𝓏 , {r}_{0} ) {β}_{i} Deformation {f}_{1} + α ( {r}_{0} ) {\sum }_{j = 1}^{{κ}_{2}} {ϕ}_{j} ( θ , 𝓏 ) {γ}_{jk} Roughness {f}_{2} + ε Measurement error \qquad ( 1 )$$

$$ε \sim 𝒩 ( 0 , {σ}^{2} )$$

wherein:
yₖ(z,t,Ro) is the deviations;
rₒ is a target radius at position z;
θ, z, rₒ are cyclindrical coordinates:
ψ and ϕ are basis expansion functions;
κ₁ and κ₂ are the number of basis functions ψ and ϕ, respectively;
β and γₖ are coefficient vectors for the basis expansion functions;
   α(·) is a function that captures size effects over a roughness pattern;
   σ² is a variance of measurement error; and [symbol]
   is the normal distribution.

In this refinement, an optimal compensation plan is given by:

$$δ ( θ , z , {r}_{o} ) = - \frac{{f}_{1} ( θ , z , {r}_{o} )}{1 + {f}_{1}^{′} ( θ , z , {r}_{o} )}$$

wherein:
θ, z, rₒ are cyclindrical coordinates:
δ(θ, z, rₒ) are the optimal compensations;
f₁(θ, z, rₒ) is a deformation; and
f₁′(θ, z, rₒ) is a partial directive of f₁(θ, z, rₒ) with respect to rₒ.

In a variation, deformation and roughness patterns are learned from the set of training objects by training a machine learning algorithm. Typically, deformation and roughness patterns are leaned from the set of training objects by training a machine learning algorithm such that once trained provides deviations and/or the compensation plan for the target object. Examples of machine learning algorithm include, but are not limited to, support vector machines, regression tree systems, gradient tree enhancement systems, neural networks, Bayesian neural networks, k nearest neighbor algorithms, random forest algorithms, and combinations thereof.

As set forth above, the computer implements steps set forth above can be implemented by a computer program executing on a computing device. FIG. 3C provides a block diagram of a computing system that can be used to implement the methods. Computing system 12 includes a processing unit 52 that executes the computer-readable instructions for the computer-implemented steps. Processing unit 52 can include one or more central processing units (CPU) or microprocessing units (MPU). Computer system 12 also includes RAM 54 or ROM 56 that can have computer implemented instructions encoded thereon. In some variations, computing device 12 is configured to display a user interface on display device 68.

Still referring to FIG. 3C, computer system 12 can also include a secondary storage device 58, such as a hard drive. Input/output interface 60 allows interaction of computing device 12 with an input device 62 such as a keyboard and mouse, external storage 64 (e.g., DVDs and CDROMs), and a display device 28 (e.g., a monitor). Processing unit 52, the RAM 54, the ROM 56, the secondary storage device 58, and the input/output interface 60 are in electrical communication with (e.g., connected to) bus 68. During operation, computer system 12 reads computer-executable instructions (e.g., one or more programs) recorded on a non-transitory computer-readable storage medium which can be secondary storage device 58 and or external storage 64. Processing unit 52 executes these reads computer-executable instructions set forth above. Specific examples of non-transitory computer-readable storage medium for which executable instructions for the computer implements methods set forth above are encoded onto include but are not limited to, a hard disk, RAM, ROM, an optical disk (e.g., compact disc, DVD), or Blu-ray Disc (BD)™), a flash memory device, a memory card, and the like.

The following examples illustrate the various embodiments of the present invention. Those skilled in the art will recognize many variations that are within the spirit of the present invention and scope of the claims.

1. WAAM Manufacturing of Cylindrical Walls

We conduct two sets of experiments to validate the proposed shape deviation learning and compensation approach. The first set keeps part design and WAAM settings unchanged to investigate the performance of a GMAW based WAAM process. In traditional GMAW, welding deposits a small amount of material and it is constrained by surrounding material, parent material, or base plates. In GMAW based WAAM, material has more deformation freedom as it is constrained only by the previous layers with increasing freedom as deposition moves away from the base plate. After a certain height, the effect of gravity and material thermal properties become more important for the printing quality. Subsequent layer deposition partially remelts the previously deposited layers and acts as a post heat treatment. The thickness of heat-treated material will be highly dependent on the processing parameters. Larger deformation can be expected if the part is overheated resulting in poor material thermal mechanical properties. Rougher surface finishing can be expected in case of accumulated heat in the deposited material that changes the bead or increases arc instability. Without changing the process parameters, the second set of experiments only modifies the part design to validate the model prediction and derived optimal compensation plan.

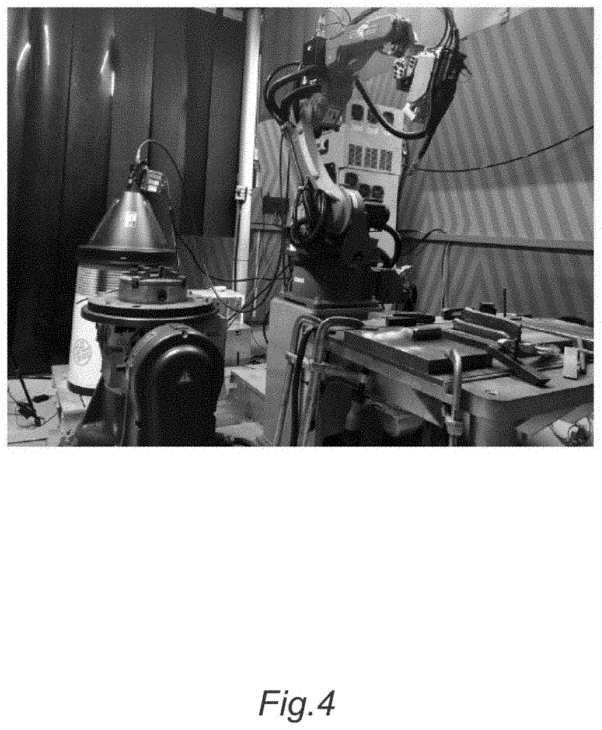

The part design for experimentation is chosen to be cylindrical wall with different radii. To Fabricate WAAM parts, designers need to consider deposition efficiency, residual stresses, final part distortion. Part geometries can be decomposed into features that affect geometric accuracy as crossings, straight, and curved structures. The continuous and symmetrical shape of cylindrical walls offers a shape deviation pattern representative of common curved structures. However, a cylindrical geometry is one of the most difficult WAAM features to manufacture, as a strategy should be used to avoid arc igniting and extinguishing defects that affect the cylindrical shape, straightness, surface roughness, and flatness of the top surface. The region of the layer adjacent to the arc ignition has an excessive thickness in contrast to its central part due to the heat sink effect of the base metal [7]. In contrast, the layer is thinner at the arc extinguishing region due to the arc pressure on the molten pool. Cylindrical feature has therefore routinely been chosen for WAAM process characterization. We investigate the geometrical deformation of cylindrical features by fabricating cylindrical walls with several radii using a GMAW system. The system includes a Panasonic TM-1400WGIII-SAWP 5-axis welding robot, equipped with an additional 2-axis workpiece manipulator (type YA-1RJC62) with a maximum handling capacity of 300 kg, as shown in FIG. 4.

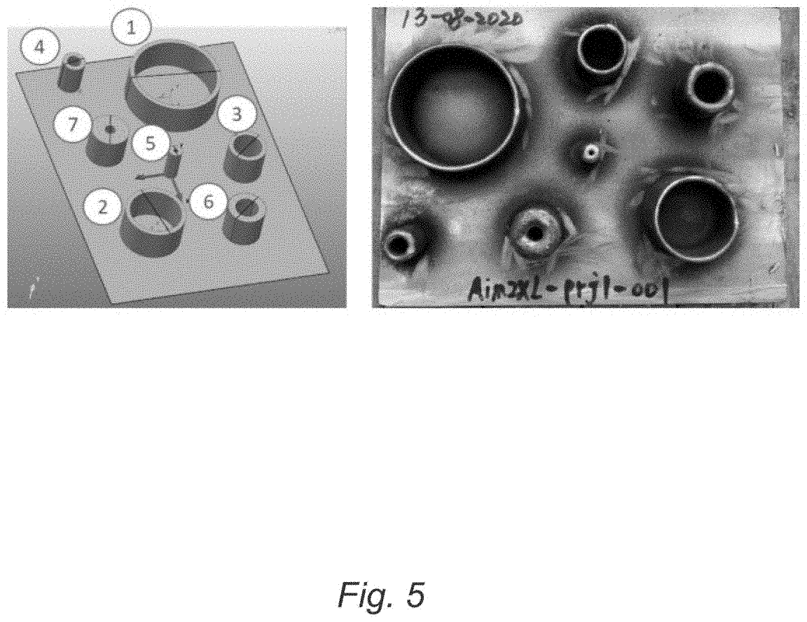

Deposition was carried out on a S355 J2 steel base plate (300×400×30 mm). The consumable solid wire electrode was stainless steel 316L with a diameter of 1.2 mm. The chemical compositions of the used wire is given in Table 2. Deposition experiments were conducted using the Panasonic SAWP welder with shielding gas Inomaxx® plus (35% helium and 2% carbon dioxide in argon) at a gas flow rate of 22 liters per minute. The contact tip was positioned at 15 0.5 mm from the workpiece. FIG. 5 shows the samples manufactured and Table 1 shows the radius, thickness and main process parameters for the deposition of various cylindrical walls. The specimens were placed with clamps during welding and subsequent cooling process.

Geometrical measurements are collected as point clouds to assess the geometric accuracy of manufactured parts. The measurement methodology must be robust to target instability, surface roughness, user-friendly and cost-effective. The structured light 3D scanning technique has the desired characteristics and precision of approximately 100 μm, which is appropriate for WAAM produced parts. We confirmed the accuracy of our structured light scanner by using a metal calibration block and observed the accuracy of approximately 50 to 100 μm. To improve data quality, measured parts were fitted with reference points and a thin layer of antireflection cover powder (FabConstru L500 Matteringspray) was applied before the scanning process. The point-clouds use Cartesian coordinates with axis aligned to the printing direction using the reference points.

TABLE 1
Main process parameters used to manufacture the samples.
Deposition speed (DS) and Wire feed speed (WFS)

| | Cylindrical Wall | | | | | | |
|---|---|---|---|---|---|---|---|
| | 1 | 2 | 3 | 4 | 5 | 6 | 7 |
| Radius (min) | 60 | 40 | 25 | 15 | 10 | 25 | 25 |
| Thickness (mm) | 6 | 6 | 6 | 6 | 6 | 10 | 18 |
| Current (A) | 140 | 140 | 140 | 140 | 130 | 105 | 142 |
| Voltage (V) | 15.4 | 15.4 | 15.4 | 15.4 | 15.4 | 14.1 | 15.8 |
| DS (m/min) | 0.75 | 0.75 | 0.75 | 0.75 | 1.00 | 0.25 | 0.17 |
| WFS (m/min) | 4.20 | 4.20 | 4.20 | 4.20 | 3.80 | 2.50 | 4.20 |

TABLE 2
Nominal composition of the stainless steel (SS) welding wire.

Chemical Composition (wt %)

| Alloy | C | Cr | Ni | Mn | Si | Mo | Fe |
|---|---|---|---|---|---|---|---|
| SS 316L | 0.01 | 18.5 | 12.2 | 1.8 | 0.8 | 2.5 | Re. |

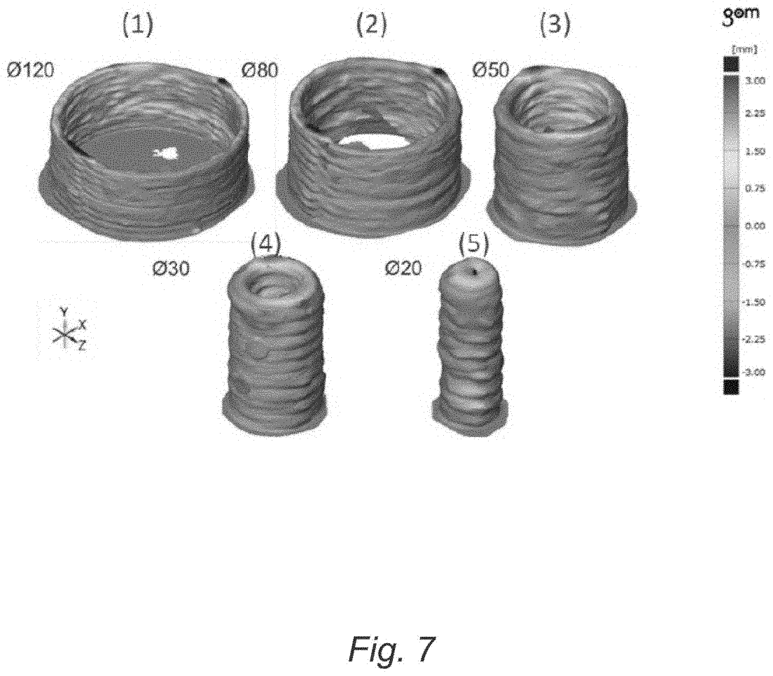

The 6 mm thick cylindrical walls were selected for analysis and the shape deviation from their designs is shown in FIG. 7. Positive deviation (red) indicates that the mesh surface is higher than the nominal file, whereas negative deviation (blue) indicates that the mesh surface is lower. Deviation ranges from −1 to 3 mm. The most significant deformation and the largest amount of error are found at the start and end welds. The 10 mm radius part does not meet print specifications. The instability of the WAAM process (spatter) causes the abundance of extra material on the surface of the parts

2. A Generalized Additive Model (GAM) for Shape Deviation Modeling and Compensation in WAAM

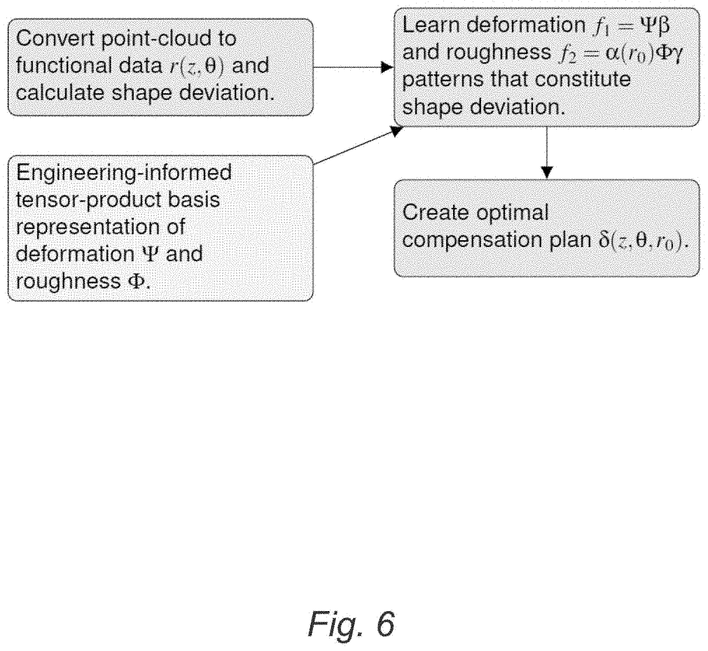

Our goal is to improve shape accuracy by compensating the CAD design for the global deformation trends observed across multiple parts. To learn these trends, we propose a GAM framework to decompose complex shape deviation profiles into low-order global deformation and high order surface roughness patterns as illustrated in FIG. 6. The first step is to convert point-cloud data to an appropriate functional representation in Subsection 2.1. The second step is to learn the deformation and roughness information and create the optimal geometric compensation plan in Subsection 2.2. The specific models for cylindrical walls are introduced in Subsection 2.3.

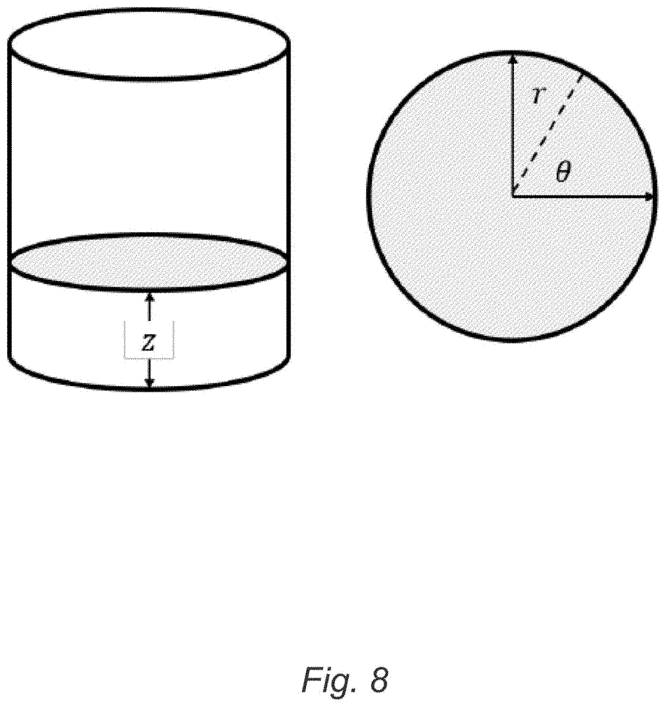

2.1 Functional Representation of Shape Deviation. Similar to [25, 30], we transform the point-cloud data to a functional representation of the 2D shape deviation at any given height (in-plane shape deformation). Since all layers have the same radius, we chose the cylindrical coordinates system (CCS) for functional representation. Each point is described by a height z, angle Θ E [0,2π], and a radius r(z, θ) as illustrated in FIG. 8. Shape deviation is defined as

y(θ,z)=r(θ,z)−r₀(θ,z)

where r₀ is the nominal (designed) radius and r is the measured radius. FIG. 1 shows the deviation of the cylindrical wall with 60 mm radius in the CCS.

2.2 GAM Modeling of Shape Deviation. We model the shape deviation of WAAM built parts as a GAM [43]. In general, a GAM mathematically links the sum of functions f of the covariates to the expected value of the observed data through a link function. For shape deviation data, the covariates are 0, z, and target radius r₀, we consider the identity link function (i.e., Gaussian distribution of the data) and the functions of the covariates capture a global shape deformation pattern f₁ due to geometric approximation and material related distortion and local surface roughness f₂ induced by process instability. For part k, these effects are represented using basis expansions as follows

$${y}_{k} ( 𝓏 , θ , {r}_{0} ) = {\sum }_{i = 1}^{{κ}_{1}} {Ψ}_{i} ( θ , 𝓏 , {r}_{0} ) {β}_{i} Deformation {f}_{1} + α ( {r}_{0} ) {\sum }_{j = 1}^{{κ}_{2}} {ϕ}_{j} ( θ , 𝓏 ) {γ}_{jk} Roughness {f}_{2} + ε Measurement error \qquad ( 1 )$$

$$ε \sim 𝒩 ( 0 , {σ}^{2} )$$

where rₒ(z, θ) is reduced to rₒ for cylindrical walls. ψ and φ are basis expansion functions with κ₁ and κ₂ dimensions, respectively. β and γₖ are the vectors of coefficients for the basis expansions. α(·) is a function that captures the size effects over the roughness pattern. We assume that deformation can be represented with relatively few basis while the roughness is captured using a larger number of basis, i.e. κ₁»κ₂. Lastly, σ² is the variance of the measurement error.

The model in matrix notation is

yₖ=Ψₖβ+Φₖγₖ+ε, (2)

where yₖ is the vector of observed deviation in part k, Ψₖ and Φₖ are matrices with each row i being the basis expansion ψ and α(r₀)φ evaluated at point i of part k, respectively. These basis expansions are constructed as tensor-products of univariate basis as explained in Section 2.3. Parameters are estimated by maximizing the penalized log-likelihood function of the form [43]:

$${ℒ}_{P} ( β , {γ}_{1} , … {γ}_{K} ) = ℒ ( β , {γ}_{1} … {γ}_{K} ) - {\sum \text{?}}_{∈ {Θ}^{1}} {λ}_{1 ,} \text{?} {β}^{T} {S}^{1} \text{?} β - {\sum \text{?}}_{∈ {Θ}^{2}} {λ}_{2 ,} \text{?} {\sum }_{k = 1}^{K} {γ}_{k}^{T} {S}_{k ,}^{2} \text{?} {γ}_{k} \qquad ( 3 )$$

$$\text{?} \text{indicates text missing or illegible when filed}$$

where K is the number of parts in the data set, [symbol] (·) is the log-likelihood function, λ are smoothing parameters, Θ¹={θ, z, r₀}, Θ¹={θ, z}, and Sᵥ¹ and S_{k,v}² for k=1, . . . , K are tensor-product penalty matrices, constructed as in [44]. Restricted maximum likelihood method (REML) is used for parameter estimation and generalized cross-validation for selection of smoothing parameters [45].

As in the study [25], the purpose of modeling the shape deviation is to reduce it by using geometric compensation (GC) which is the process of introducing adjustment δ(θ, z, r0) to the original design and print r*=r0+δ in order to achieve the desired shape [26]. In [25], GC is done on boundary points of a design. However, thick layers in WAAM requires the compensation to be done layer-wise to reduce in-plane shape deviation of each layer. Moreover, compensation only corrects the deviation due to the shape deformation pattern f (z, (θ, z, r0)=ψ(θ, z, r0)^{T}β while surface roughness can only be reduced through process optimization and control. The optimal in-plane compensation plan is [33]

$$δ ( θ , 𝓏 , {r}_{0} ) = - \frac{{f}_{1} ( θ , 𝓏 , {r}_{0} )}{1 + {f}_{1}^{′} ( θ , 𝓏 , {r}_{0} )} \qquad ( 4 )$$

where f₁′(θ, z, r₀) is the partial derivative of f₁ with respect to r₀. We use the mid-point of each layer to determine z.

2.3 Engineering-Informed Tensor-Product Basis for Cylindrical Walls. Two popular approaches for constructing multivariate basis functions is the use of isotropic basis (i.e., functions to model the effects of z and r0 on the deformation pattern.

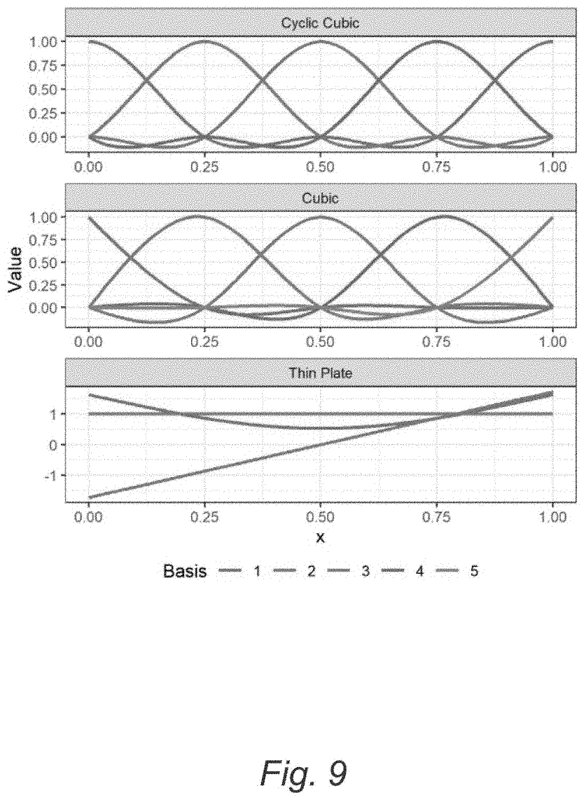

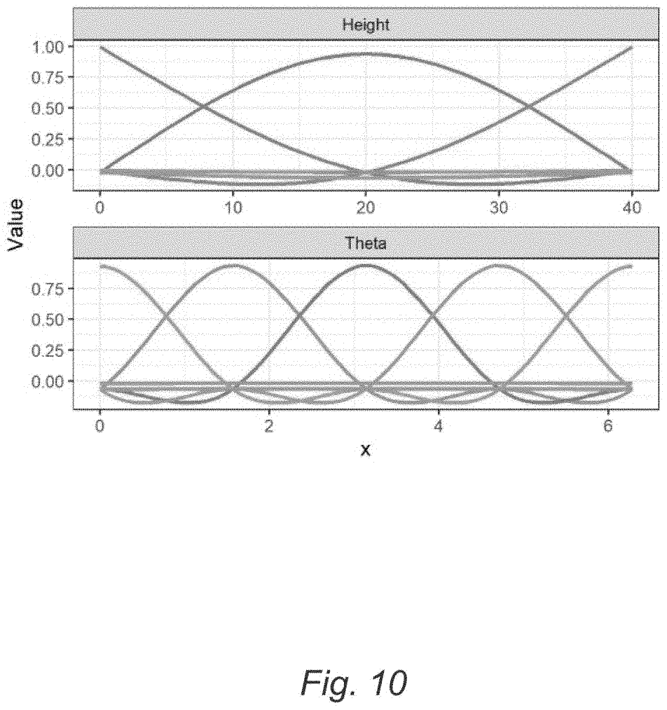

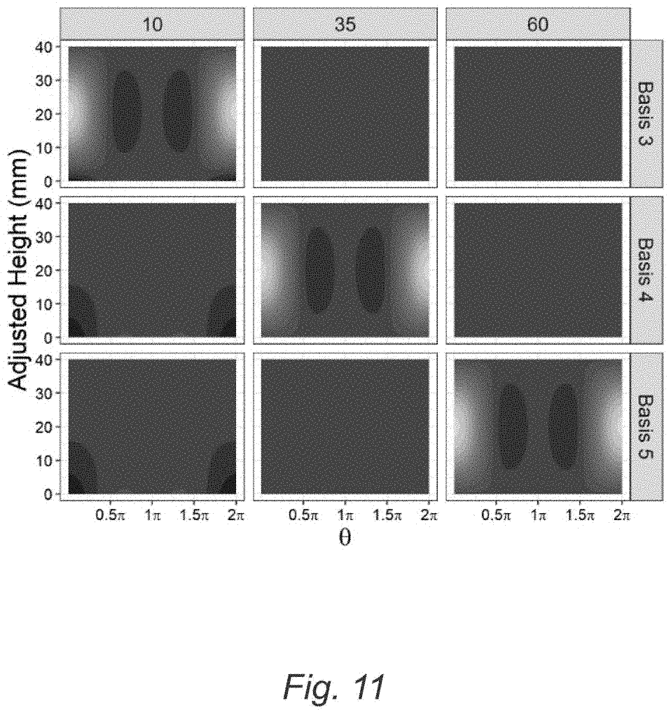

FIG. 9 shows the first five cubic, four cyclic cubic, and three TPRS basis functions. Note that cubic and cyclic cubic basis are very similar in terms of the maximum points but have a very different behavior on the tails. FIG. 10 shows the tensor product basis with 5 cyclic cubic basis for r₀, 3 TPRS for z, and 3 TPRS for r₀. The top plot shows the result by fixing r₀=35 mm and 0=π and the bottom plot shows the result by fixing r₀=35 mm and z=20. Note that the tensor product produces 36 basis (35 after enforcing identifiability constraints) but only a few basis are observed in both plots due to multiple functions having the same pattern in these ranges. FIG. 11 presents the surface plots of the three tensor-product basis for multiple radii with the a similar pat tern in z and θ shifting on its range for each basis. The highorder tensor-product interaction terms that model roughness have a similar behavior with a faster reduction on the basis value. Note that the magnitude of γⱼ can be interpreted as the presence of a local deformation due to roughness at the locations with high values of φⱼ.

To assess the effect of roughness over the predicted deformation profile, we construct three increasingly complex models using these basis functions. (1) Fixed effects (FE) serves as a baseline model that considers only the deformation functions w. It is constructed using 5 cyclic cubic basis for θ, 3 TPRS for z, and 3 TPRS for r0. Note that at most a univariate quadratic relationship between z or r₀ and the deviation profile can be modeled since only a few cylinders of different sizes were manufactured. The resulting basis functions are illustrated in FIGS. 10 and 11. (2) Scaled roughness (SR) is an extension of FE where the roughness is modeled using a high order tensor-product basis scaled by α(r₀)=r₀. The basis functions φ are constructed 16 cyclic cubic basis for θ and 32 cubic basis for z such that it absorbs the cyclical vertical patterns associated with thick layers in WAAM. Row i of Φ is r₀φ evaluated at point i. (3) Gaussian process (GP) is also an extension of FE where the roughness is approximated using GP basis [46] for each cylinder, α(r₀)=1 and row i of Φ is φ evaluated at point i.

Gaussian processes are a popular choice for nonparametric modeling of smooth functions [47]. For regression, they assume that outputs y are jointly normally distributed with covariance constructed using a function of the distance between the features x of the observations. For computational tractability, GP basis are low-rank basis functions built from the approximated covariance between observations. The procedure consists of selecting a subset of representative observations (knots) and computing the covariance matrix Ω=Ω₁Ω₂, where Ω₁ is the covariance between the points in the sample and the knots, and Ω₂ is the covariance between knots. ϕ is constructed as a tensor-product of univariate GP smooths using 16 knots with radial [43] covariance function for θ and 32 knots with Matern covariance function with shape [symbol] =2.5 for z. In each dimension a, ϕ^{a} is the rows of Ω^{a}.

3. Validation Study of the Proposed Methodology

The proposed shape deviation modeling framework can provide valuable insights for pre and post processing optimization. For the geometrical feature studied here, the models were trained using the point-cloud data of the cylindrical walls with 60 mm, 40 mm, and 15 mm radius (FIG. 5). The 25 mm cylindrical wall was used as validation data, and the compensation plans were created for a new 50 mm cylindrical wall. The 10 mm cylinder was excluded from this study because it does not meet the printing quality requirements, the process parameters were different, and most of the deviation patterns are caused by surface roughness. Due to the initial layers melting with the printing base and the excess material on the last layer printed, only layers 3 to 18 are considered for prediction and compensation. The number of data points in each point-cloud was uniformly downsampled to 3600 points to avoid overfitting the models to the patterns observed in the larger cylindrical walls. In addition, the height z is adjusted to z=0 at the bottom of layer 3 for all data sets. All models were fitted using the mgcv pack age in R [43]. The predicted shape deviation is presented in Subsection 3.1, followed by associated compensation plan in Subsection 3.2.

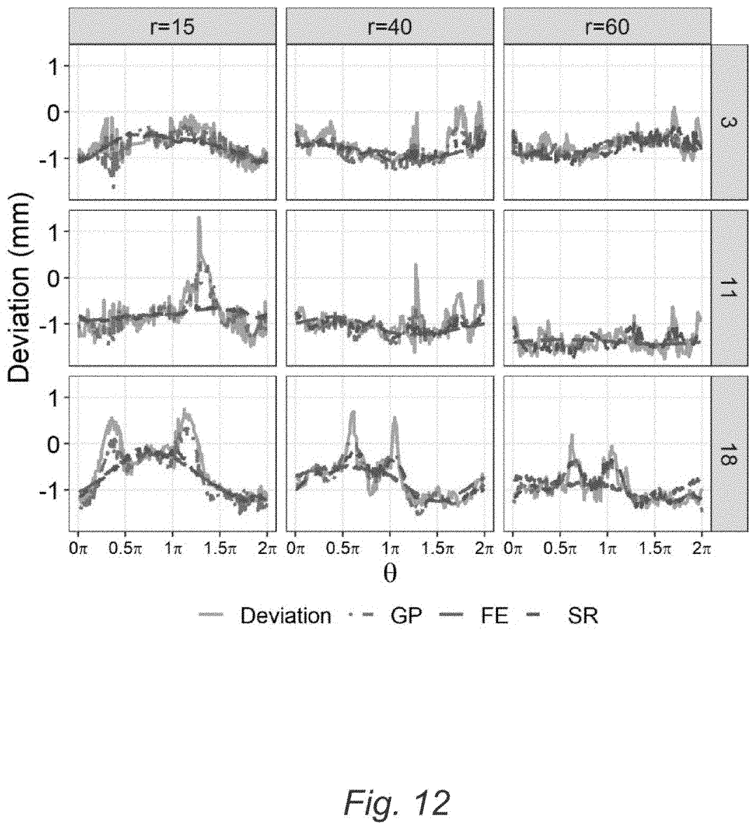

3.1 Predicted Shape Deviation. We examine the performance of the three shape deviation models to predict the deformation of the parts in the training data set and to predict the deformation (without roughness) of the 25 mm cylindrical wall. FIG. 12 presents the prediction of the three models for layers at the bottom (3), middle (11), and top (18) of the cylindrical walls in the training data set. The highest deviations are visible as peaks at each welding joint. The FE model captures most of the deformation pattern layer-wise. The SR and GP models have a similar performance for the larger cylindrical walls. However, the GP method has a considerably better predictive fit for the smaller cylindrical wall. This suggests that a linear relationship between the roughness pattern and r0 might be inadequate when r0 is too small.

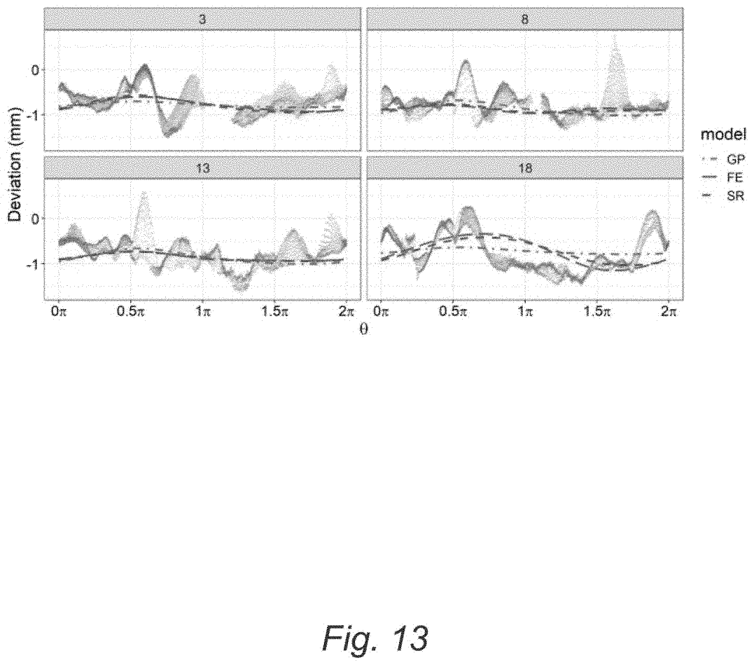

FIG. 13 presents the predicted shape deformation (without roughness pattern) for the cylindrical wall of r0=25 mm. For this cylinder, the height z was unavailable and prediction of the shape deformation is based on the mid-point height of 2.5 mm thick layer which increases the error. FE and SR seem to perform better than GP because the roughness pattern is too strong in the later which reduces its predictive performance for new cylinders.

3.2 Reduction of Shape Deviation Through Compensation. Compensation is defined as modifications to the CAD model that lead to a controlled deformation of the printed part and improved accuracy with respect to the target geometry. Similar to [48], overall deviation per unit-of-area is measured as the absolute change in the external area of the thin walled shapes per unit-of-area, calculated as follows

$$η = \frac{Δ S}{S} \qquad ( 6 )$$

here S=2πr₀z* is the nominal area for a cylinder with maximum height z*, ΔS is the absolute area change approximated as

$$Δ S = {\int }_{0}^{{𝓏}^{⋆}} {\int }_{0}^{2 π} \vert y ( θ , 𝓏 ) \vert d θ d 𝓏 \approx {\sum }_{i = 1}^{n} {\sum }_{j = 1}^{n} \vert {\overline{y}}_{i , j} \vert w ,$$

with the range of θ and z segmented into n×n cells of area w and γ̅_{i,j} is the mean deviation of points in cell i, j.

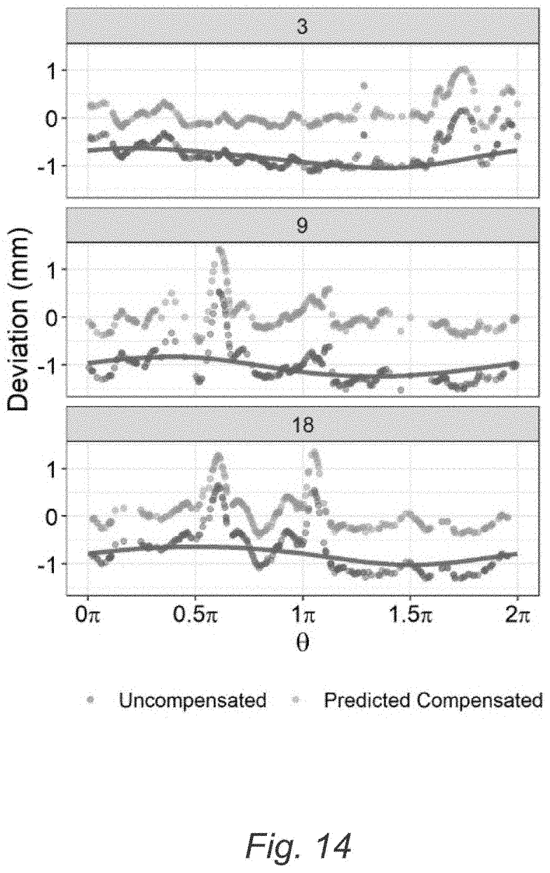

To illustrate the expected impact of compensation, FIG. 14 shows the predicted shape deviation for the 40 mm cylindrical wall after optimal compensation under the SR model which is calculated as

ŷ(θ,z,r₀,δ)=f₁(θ,z,r₀+δ)+y(θ,z,r₀)−f₁(θ,z,r₀)

for each data point. The compensated shape deviation is expected to be centered around zero with over 1 mm of extra material in the arc ignition locations. The mean absolute deviation is expected to diminish from 0.96 per mm2 to 0.22 per mm2, which implies a 76% reduction in the best case.

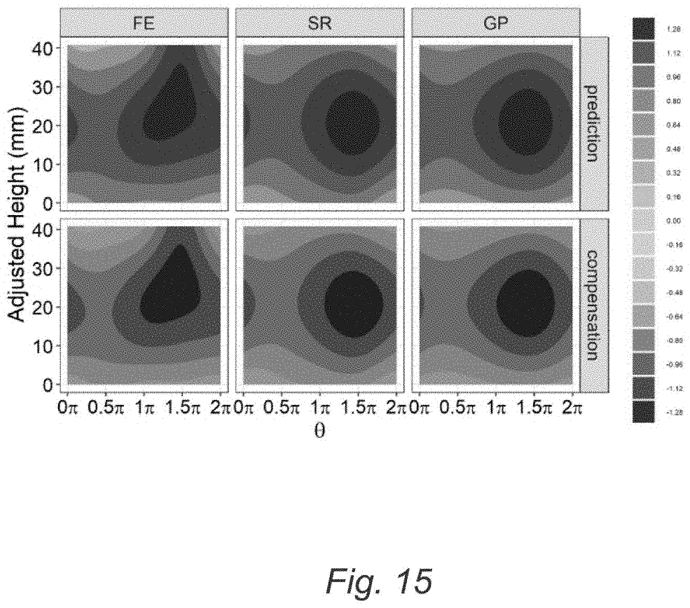

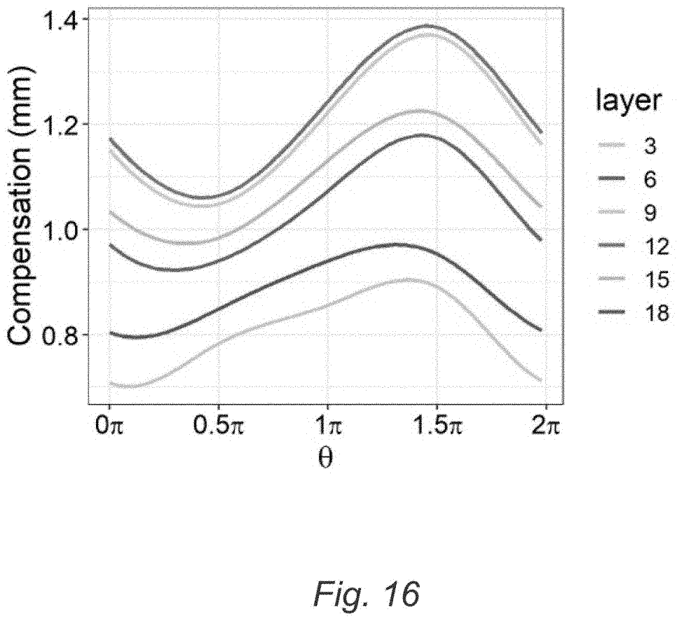

Experimental compensation is done for a new cylindrical wall with r0=50 mm. As discussed above, the main deformation patterns can be predicted for cylindrical walls of reasonable radius. FIG. 15 shows the predicted deformation and the optimal in-plane compensation plan at any height. GP and SR have a similar deviation profile and compensation. Since FE does not consider surface roughness, the FE predictions and compensation plan have a more complicated pattern than the other two models. The SR model was used to compensate the design of a new r0=50 mm cylindrical wall. The layer-wise in-plane compensation plan is shown in FIG. 16. Note that compensation starts relatively small, then increases at the middle layers, and lessens again at the top layers.

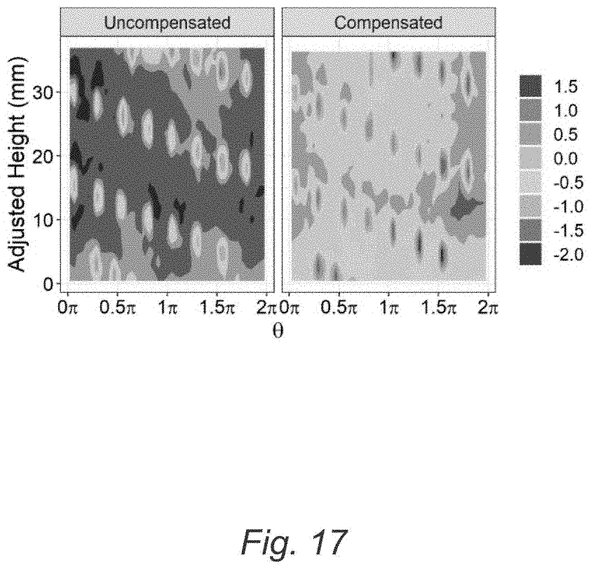

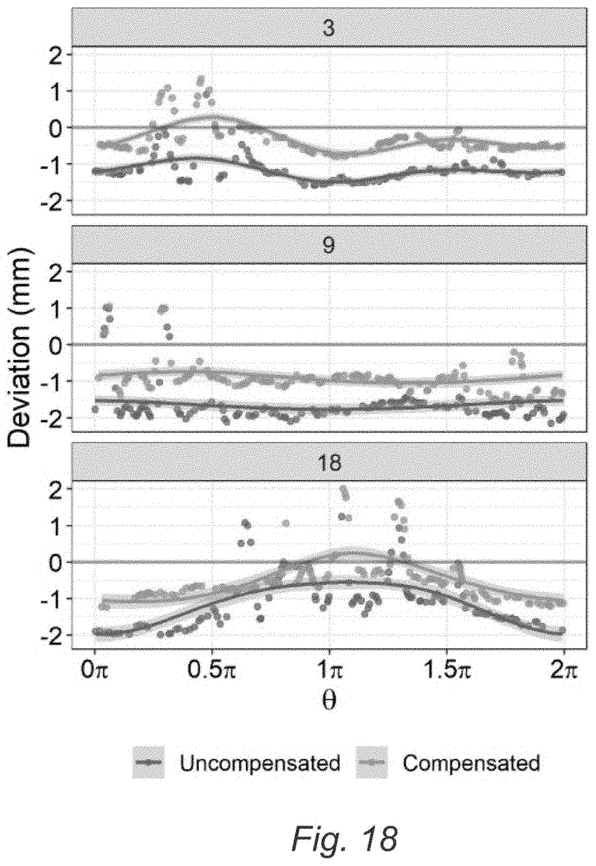

For the new 50 mm cylindrical wall, the shape deviation pattern is greatly reduced after compensation, as shown in FIG. 17. The absolute deviation per mm2 is 1.51 and 0.80 for the uncompensated and compensated parts, respectively. This translates to a 47.3% reduction in overall shape deviation. FIG. 18 presents the shape deviation patterns and their respective smooth deformations at the center of layers 3, 9, and 18 of the parts. The overall patterns show a similar behavior to those predicted in FIG. 14. The smooth trends illustrate the effect of the local roughness and the accumulation of material at the arc ignition points over the shape deviation. However, the parts present an overall shrinkage not predicted by our model.

3.3 Discussion. Although the proposed prescriptive methodology significantly reduces the overall shape deviation, the dimensional quality of WAAM manufactured components is affected by a number of factors, including environmental conditions, material fluctuations, and changing thermo-mechanical boundary conditions. The deposition parameters utilized in this study caused some significant geometric irregularities. In particular, unforeseen material and environmental changes, such as air flow altering the printing interpass temperature, might have modified the deformation pattern in the second experiment. Consequently, the bumps at the arc ignition locations are more visible in FIG. 17 than in FIG. 1. Measurement and point cloud data registration may also have introduced errors. Lastly, the framework in this study could benefit practitioners in the following aspects:

1. Product designers can analyze the predicted deformation patterns of new parts in the initial design stages. Apart from the design freedom provided by WAAM, this ensures that deposition paths that improve geometric accuracy can be achieved early in the design process.

2. The usage of this framework by operations engineers minimizes the need for them to deeply understand the complexities of the process, facilitating decisionmaking, improving part accuracy, and helping automate the WAAM process.

4. Conclusions

In this work, we propose a prescriptive modeling and compensation framework to reduce shape deformation in WAAM build products. Shape deviation is more complex in WAAM due to process instability and highly nonlinear stress profiles caused by the high-temperature processes. We model shape deviation as a generalized additive model (GAM) that decomposes deviation into global deformation and local roughness patterns. Tensor-basis expansions of local geometric features in the cylindrical coordinates system are used to predict shape deviation. Each univariate basis is chosen based on engineering considerations of each geometric feature to obtain meaningful and interpretable results with a few samples. To study the effect of roughness on the deformation prediction, we construct three models with increasing complexity. The FE model considers global deformation, the SR model considers global deformation and local roughness scaled by the part size, and the GP model considers global deformation with Gaussian process basis for the roughness of each individual part.

Experimental validation on cylindrical walls demonstrates the predictive and prescriptive capabilities of the proposed framework. We manufactured four equally tall cylindrical walls with radii 15, 25, 40, and 60 mm using a GMAW system. By considering roughness, the SR and GP models have a better overall deviation prediction performance than the FE model while retaining a complex enough deformation pattern for effective compensation. The optimal geometric compensation of a new 50 mm cylindrical wall results in a 47.3% reduction of absolute deviation per mm2.

The proposed shape deviation methodology can be applied to a broad category of WAAM as well as AM processes to manufacture smooth geometries. Using the equivalence effects principle, model transfer between materials and WAAM processes can be achieved by adding a new term to capture the differences among their shape deviation profiles [30, 34]. Further research is needed to predict the shape deformation patterns of crossing and straight structures as well as the effect of relevant process parameters for specific WAAM processes. The methodology may potentially be extended to integrate real-time in-situ data to further improve shape accuracy.

Additional details of the invention are found in Cesar Ruiz, Davoud Jafari, Vignesh Venkata Subramanian, Tom H. J. Vaneker, Wei Ya, Qiang Huang, Prediction and Control of Product Shape Quality for Wire and Arc Additive Manufacturing, J. Manuf. Sci. Eng. November 2022, 144(11): 111005 (11 pages) (Paper No: MANU-21-1489 https://doi.org/10.1115/1.4054721); the entire disclosure of which is hereby incorporated by reference.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

[1] Gibson, I., Rosen, D., and Stucker, B., 2009. Additive Manufacturing Technologies: Rapid Prototyping to Direct Digital Manufacturing. Springer US.
[2] Jafari, D., Wits, W. W., Vaneker, T. H., Demir, A. G., Previtali, B., Geurts, B. J., and Gibson, I., 2020. “Pulsed mode selective laser melting of porous structures: Structural and thermophysical characterization”. Additive Manufacturing, 35, p. 101263.
[3] Ding, D., Pan, Z., Cuiuri, D., and Li, H., 2015. “Wire-feed additive manufacturing of metal components: technologies, developments and future interests”. The International Journal of Advanced Manufacturing Technology, 81(1), pp. 465-481.
[4] Bourell, D., Kruth, J. P., Leu, M., Levy, G., Rosen, D., Beese, A. M., and Clare, A., 2017. “Materials for additive manufacturing”. CIRP annals, 66(2), pp. 659-681.
[5] Mughal, M., Fawad, H., and Mufti, R., 2006. “Threedimensional finite-element modelling of deformation in weld-based rapid prototyping”. Proceedings of the Institution of Mechanical Engineers, Part C: Journal of Mechanical Engineering Science, 220(6), pp. 875-885.
[6] Karunakaran, K., Suryakumar, S., Pushpa, V., and Akula, S., 2010. “Low cost integration of additive and subtractive processes for hybrid layered manufacturing”. Robotics and Computer-Integrated Manufacturing, 26(5), pp. 490-499.
[7] Jafari, D., Vaneker, T. H., and Gibson, I., 2021. “Wire and arc additive manufacturing: Opportunities and challenges to control the quality and accuracy of manufactured parts”. Materials & design, 202, p. 109471.
[8] Panchagnula, J. S., and Simhambhatla, S., 2018. “Manufacture of complex thin-walled metallic objects using weld-deposition based additive manufacturing”. Robotics and Computer-Integrated Manufacturing, 49, pp. 194-203.
[9] Zhu, Z., Anwer, N., Huang, Q., and Mathieu, L., 2018. “Machine learning in tolerancing for additive manufacturing”. CIRP Annals, 67(1), pp. 157-160.
[10] Ding, D., Pan, Z., Cuiuri, D., Li, H., Larkin, N., and Van Duin, S., 2016. “Automatic multi-direction slicing algorithms for wire based additive manufacturing”. Robotics and Computer-Integrated Manufacturing, 37, pp. 139-150.
[11] Ding, J., Colegrove, P., Mehnen, J., Ganguly, S., Almeida, P. S., Wang, F., and Williams, S., 2011. “Thermo-mechanical analysis of wire and arc additive layer manufacturing process on large multilayer parts”. Computational Materials Science, 50(12), pp. 3315-3322.
[12] Xiong, J., Li, R., Lei, Y., and Chen, H., 2018. “Heat propagation of circular thin-walled parts fabricated in additive manufacturing using gas metal arc welding”. Journal of Materials Processing Technology, 251, pp. 12-19.
[13] Martina, F., Colegrove, P. A., Williams, S. W., and Meyer, J., 2015. “Microstructure of interpass rolled wire+ arc additive manufacturing ti-6a1-4v components”. Metallurgical and Materials Transactions A, 46(12), pp. 6103-6118.
[14] Cunningham, C., Flynn, J., Shokrani, A., Dhokia, V., and Newman, S., 2018. “Invited review article: Strategies and processes for high quality wire arc additive manufacturing”. Additive Manufacturing, 22, pp. 672686.
[15] Pan, Z., Ding, D., Wu, B., Cuiuri, D., Li, H., and Norrish, J., 2018. “Arc welding processes for additive manufacturing: a review”. Transactions on intelligent welding manufacturing, pp. 3-24.
[16] Wu, B., Pan, Z., Ding, D., Cuiuri, D., Li, H., Xu, J., and Norrish, J., 2018. “A review of the wire arc additive manufacturing of metals: properties, defects and quality improvement”. Journal of Manufacturing Processes, 35, pp. 127-139.
[17] Jin, W., Zhang, C., Jin, S., Tian, Y., Wellmann, D., and Liu, W., 2020. “Wire arc additive manufacturing of stainless steels: a review”. Applied sciences, 10(5), p. 1563.
[18] Zhao, H., Zhang, G., Yin, Z., and Wu, L., 2011. “A 3d dynamic analysis of thermal behavior during single-pass multilayer weld-based rapid prototyping”. Journal of Materials Processing Technology, 211(3), pp. 488-495.
[19] Cohen, D. L., and Lipson, H., 2010. “Geometric feedback control of discrete-deposition sff systems”. Rapid Prototyping Journal.
[20] Heralic, A., Christiansson, A.-K., and Lennartson, B., 2012. “Height control of laser metal-wire deposition based on iterative learning control and 3d scanning”. Optics and lasers in engineering, 50(9), pp. 12301241.
[21] Xiong, J., and Zhang, G., 2014. “Adaptive control of deposited height in gmaw-based layer additive manufacturing”. Journal of Materials Processing Technology, 214(4), pp. 962-968.
[22] Garmendia, I., Leunda, J., Pujana, J., and Lamikiz, A., 2018. “In-process height control during laser metal deposition based on structured light 3d scanning”. Procedia CIRP, 68, pp. 375-380. 19th CIRP Conference on Electro Physical and Chemical Machining, 23-27 Apr. 2017, Bilbao, Spain.
[23] Wang, Y., Lu, J., Zhao, Z., Deng, W., Han, J., Bai, L., Yang, X., and Yao, J., 2021. “Active disturbance rejection control of layer width in wire arc additive manufacturing based on deep learning”. Journal of Manufacturing Processes, 67, pp. 364-375.
[24] Xiong, J., Zhang, G., Hu, J., and Li, Y., 2013. “Forecasting process parameters for gmaw-based rapid manufacturing using closed-loop iteration based on neural network”. The International Journal of Advanced Manufacturing Technology, 69(1-4), pp. 743-751.
[25] Huang, Q., Zhang, J., Sabbaghi, A., and Dasgupta, T., 2015. “Optimal offline compensation of shape shrinkage for three-dimensional printing processes”. IIE Transactions, 47(5), pp. 431-441.
[26] Huang, Q., Nouri, H., Xu, K., Chen, Y., Sosina, S., and Dasgupta, T., 2014. “Statistical predictive modeling and compensation of geometric deviations of threedimensional printed products”. Journal of Manufacturing Science and Engineering, Transactions of the ASME, 136(6), pp. 1-10.
[27] Luan, H., and Huang, Q., 2017. “Prescriptive modeling and compensation of in-plane shape deformation for 3D printed freeform products”. IEEE Transactions on Automation Science and Engineering, 14(1), pp. 7382.
[28] Wang, A., Song, S., Huang, Q., and Tsung, F., 2017. “In-plane shape-deviation modeling and compensation for fused deposition modeling processes”. IEEE Transactions on Automation Science and Engineering, 14(2), pp. 968-976.
[29] Luan, H., Grasso, M., Colosimo, B. M., and Huang, Q., 2019. “Prescriptive data-analytical modeling of laser powder bed fusion processes for accuracy improvement”. Journal of Manufacturing Science and Engineering, 141(1).
[30] Ferreira, R. D. S. B., Sabbaghi, A., and Huang, Q., 2020. “Automated Geometric Shape Deviation Modeling for Additive Manufacturing Systems via Bayesian Neural Networks”. IEEE Transactions on Automation Science and Engineering, 17(2), pp. 584-598.
[31] Huang, Q., Wang, Y., Lyu, M., and Lin, W., 2020. “Shape Deviation Generator-A Convolution Framework for Learning and Predicting 3-D Printing Shape Accuracy”. IEEE Transactions on Automation Science and Engineering, 17(3), pp. 1486-1500.
[32] Wang, Y., Ruiz, C., and Huang, Q., 2021. “Extended fabrication-aware convolution learning framework for predicting 3d shape deformation in additive manufacturing”. In 2021 IEEE 17th International Conference on Automation Science and Engineering (CASE), pp. 712-717.
[33] Huang, Q., 2016. “An analytical foundation for optimal compensation of three-dimensional shape deformation in additive manufacturing”. Journal of Manufacturing Science and Engineering, Transactions of the ASME, 138(6), pp. 1-8.
[34] Sabbaghi, A., and Huang, Q., 2018. “Model transfer across additive manufacturing processes via mean effect equivalence of lurking variables”. The Annals of Applied Statistics, 12(4), pp. 2409 2429.
[35] Zhou, H., Li, L., and Zhu, H., 2013. “Tensor regression with applications in neuroimaging data analysis”. Journal of the American Statistical Association, 108(502), pp. 540-552. PMID: 24791032.
[36] Yue, X., Yan, H., Park, J. G., Liang, Z., and Shi, J., 2017. “A wavelet-based penalized mixed-effects decomposition for multichannel profile detection of inline raman spectroscopy”. IEEE Transactions on Automation Science and Engineering, 15(3), pp. 12581271.
[37] Candes, E. J., Li, X., Ma, Y., and Wright, J., 2011. “Robust principal component analysis?”. Journal of the ACM, 58(3), June.
[38] Mou, S., Wang, A., Zhang, C., and Shi, J., 2021. “Additive tensor decomposition considering structural data information”. IEEE Transactions on Automation Science and Engineering, pp. 1-14.
[39] Yan, H., Paynabar, K., and Shi, J., 2017. “Anomaly detection in images with smooth background via smoothsparse decomposition”. Technometrics, 59(1), pp. 102114.
[40] , 2019. Data Decomposition for Analytics of Engineering Systems: Literature Review, Methodology Formulation, and Future Trends, Vol. Volume 1: Additive Manufacturing; Manufacturing Equipment and Systems; Bio and Sustainable Manufacturing of International Manufacturing Science and Engineering Conference.
[41] Wikle, C., Zammit-Mangion, A., and Cressie, N., 2019. Spatio-Temporal Statistics with R. Chapman & Hall/CRC The R Series. CRC Press.
[42] Wood, S. N., Pya, N., and Sa⁻fken, B., 2016. “Smoothing parameter and model selection for general smooth models”. Journal of the American Statistical Association, 111(516), pp. 1548-1563.
[43] Wood, S., 2017. Generalized Additive Models: An Introduction with R, 2 ed. CRC Press, United States.
[44] Wood, S. N., Scheipl, F., and Faraway, J. J., 2013. “Straightforward intermediate rank tensor product smoothing in mixed models”. Statistics and Computing, 23(3), pp. 341-360.
[45] Wood, S. N., 2011. “Fast stable restricted maximum likelihood and marginal likelihood estimation of semiparametric generalized linear models”. Journal of the Royal Statistical Society (B), 73(1), pp. 3-36.
[46] Kammann, E., and Wand, M. P., 2003. “Geoadditive models”. Journal of the Royal Statistical Society: Series C (Applied Statistics), 52(1), pp. 1-18.
[47] Rasmussen, C., and Williams, C., 2006. Gaussian Processes for Machine Learning. Adaptive computation and machine learning. MIT Press.
[48] Luan, H., Post, B. K., and Huang, Q., 2017. “Statistical process control of in-plane shape deformation for additive manufacturing”. In 2017 13th IEEE Conference on Automation Science and Engineering (CASE), pp. 1274-1279.

What is claimed is:

1. A method for forming a target object by wire and arc additive manufacturing, the method comprising:
a) receiving, by a computing device, an initial three dimensional model of the target object to be fabricated by wire and arc additive manufacturing;
b) applying a compensation plan to a initial three-dimensional model to form a modified three-dimensional model to compensate for deformation during fabrication of the target object, the compensation plan being determined by the computing device with a computer implement method comprising:
converting point-cloud data to functional representation for each training object in a set of training objects;
calculate total shape deviations for each training object;
constructing an engineering-informed tensor-product basis representation of deformation patterns and roughness patterns for each training object;
learning deformation patterns and roughness patterns that constitute the total shape deviations from the set of training objects; and
creating an optimal compensation plan from a predicted deformation patterns to be applied to the target object that minimizes its shape deformation; and
c) forming target object by wire and arc additive manufacturing with the modified three-dimensional model.

2. The method of claim 1, wherein the target object has a net shape.

3. The method of claim 1, wherein when the target object has a circular cross-section, the shape deviations are given by:
$${y}_{k} ( 𝓏 , θ , {r}_{0} ) = {\sum }_{i = 1}^{{κ}_{1}} {Ψ}_{i} ( θ , 𝓏 , {r}_{0} ) {β}_{i} Deformation {f}_{1} + α ( {r}_{0} ) {\sum }_{j = 1}^{{κ}_{2}} {ϕ}_{j} ( θ , 𝓏 ) {γ}_{jk} Roughness {f}_{2} + ε Measurement error \qquad ( 1 )$$
$$ε \sim 𝒩 ( 0 , {σ}^{2} )$$
wherein:
yₖ(z,t,Ro) is the deviations;
rₒ is a target radius at position z;
θ, z, rₒ are cyclindrical coordinates:
ψ and ϕ are basis expansion functions;
κ₁ and κ₂ are the number of basis functions ψ and ϕ, respectively;
β and γₖ are coefficient vectors for the basis expansion functions;
α(·) is a function that captures size effects over a roughness pattern;
σ² is a variance of measurement error; and [symbol]
is the normal distribution.

4. The method of claim 1 wherein the optimal compensation plan is determined given by:
$$δ ( θ , z , {r}_{o} ) = - \frac{{f}_{1} ( θ , z , {r}_{o} )}{1 + {f}_{1}^{′} ( θ , z , {r}_{o} )}$$
wherein:
θ, z, rₒ are cyclindrical coordinates:
δ(θ, z, rₒ) is the optimal compensations;
f₁(θ, z, rₒ) is the predicted deformation; and
f₁′(θ, z, rₒ) is a partial directive of f₁(θ, z, rₒ) with respect to rₒ.

5. The method of claim 1, wherein the optimal compensation plan minimizes the absolute volume deviations.

6. The method of claim 5, wherein the optimal compensation plan minimizes total absolute area deviation.

7. The method of claim 1, wherein the optimal compensation plan minimizes deviations for predicted deformation by calculating an amount of compensation that is equivalent to an area deviation.

8. The method of claim 1, wherein deformation and roughness patterns are leaned from the set of training objects by training a machine learning algorithm.

9. The method of claim 1, wherein deformation and roughness patterns are leaned from the set of training objects by training a machine learning algorithm such that once trained provides deviations and/or the compensation plan for the target object.

10. The method of claim 9, wherein the machine learning algorithm is selected from the group consisting of support vector machines, regression tree systems, gradient tree enhancement systems, neural networks, Bayesian neural networks, k nearest neighbor algorithms, random forest algorithms, and combinations thereof.

11. The method of claim 1, wherein step c) is performed by a wire and arc additive manufacturing machine comprising an arch torch, a wire-feed system, and a power source, the arch torch and wire-feedsystem being in electrical communication with the computing device and receiving instructions therefrom for forming the target object.

12. A method for determining a compensation plan to be applied to an initial three-dimensional model to form a modified three-dimensional model to compensate for deformation during fabrication of a target object, the method comprising:
converting point-cloud to functional data for each training object in a set of training objects;
calculate total shape deviations for each training object;
constructing an engineering-informed tensor-product basis representation of deformation and roughness patterns for each training object;
learning deformation patterns and roughness patterns that constitute the total shape deviations from the set of training objects; and
creating an optimal compensation plan from a predicted deformation patterns to be applied to the target object that minimizes its shape deformation.

13. The method of claim 12, wherein the target object has a net shape.

14. The method of claim 12, wherein when the target object has a circular cross-section, the shape deviations are given by:
$${y}_{k} ( 𝓏 , θ , {r}_{0} ) = {\sum }_{i = 1}^{{κ}_{1}} {Ψ}_{i} ( θ , 𝓏 , {r}_{0} ) {β}_{i} Deformation {f}_{1} + α ( {r}_{0} ) {\sum }_{j = 1}^{{κ}_{2}} {ϕ}_{j} ( θ , 𝓏 ) {γ}_{jk} Roughness {f}_{2} + ε Measurement error \qquad ( 1 )$$
$$ε \sim 𝒩 ( 0 , {σ}^{2} )$$
wherein:
yₖ(z,t,Ro) is the deviations;
rₒ is a target radius at position z;
θ, z, rₒ are cyclindrical coordinates:
ψ and ϕ are basis expansion functions;
κ₁ and κ₂ are the number of basis functions ψ and ϕ, respectively;
β and γₖ are coefficient vectors for the basis expansion functions;
α(·) is a function that captures size effects over a roughness pattern;
σ² is a variance of measurement error; and [symbol]
is the normal distribution.

15. The method of claim 1, wherein the optimal compensation plan is determined given by:
$$δ ( θ , z , {r}_{o} ) = - \frac{{f}_{1} ( θ , z , {r}_{o} )}{1 + {f}_{1}^{′} ( θ , z , {r}_{o} )}$$
wherein:
θ, z, rₒ are cyclindrical coordinates:
δ(θ, z, rₒ) is the optimal compensations;
f₁(θ, z, rₒ) is the predicted deformation; and
f₁′(θ, z, rₒ) is a partial directive of f₁(θ, z, rₒ) with respect to rₒ.

16. The method of claim 12, wherein the optimal compensation plan minimizes the absolute volume deviations.

17. The method of claim 16, wherein the optimal compensation plan minimizes total absolute area deviation.

18. The method of claim 12, wherein the optimal compensation plan minimizes deviations for predicted deformation by calculating an amount of compensation that is equivalent to an area deviation.

19. The method of claim 12, wherein deformation and roughness patterns are leaned from the set of training objects by training a machine learning algorithm.

20. The method of claim 12, wherein deformation and roughness patterns are leaned from the set of training objects by training a machine learning algorithm such that once trained provides deviations and/or the compensation plan for the target object.

21. The method of claim 20, wherein the machine learning algorithm is selected from the group consisting of support vector machines, regression tree systems, gradient tree enhancement systems, neural networks, Bayesian neural networks, k nearest neighbor algorithms, random forest algorithms, and combinations thereof.

22. The method of claim 12, wherein step c) is performed by a wire and arc additive manufacturing machine comprising an arch torch, a wire-feed system, and a power source, the arch torch and wire-feedsystem being in electrical communication with the computing device and receiving instructions therefrom for forming the target object.
